(19) United States
(12) Patent Application Publication
(10) Pub. No.: US 2025/0377053 A1
(43) Pub. Date: Dec. 11, 2025

(54) DEVICE FOR ACCESS TO THE ANNULAR SPACE OF SUBMARINE FLEXIBLE PIPES THROUGH RELIEF VALVES AND ASSOCIATED METHODS

(71) Applicant: PETRÓLEO BRASILEIRO S.A. – PETROBRAS, Rio de Janeiro (BR)

(72) Inventors: Marcelo DA CRUZ RODRIGUES, Rio de Janeiro (BR); Daniel GRECO DUARTE, Rio de Janeiro (BR); Volney SOARES LOPES, Rio de Janeiro (BR)

(21) Appl. No.: 19/196,105

(22) Filed: May 1, 2025

(30) Foreign Application Priority Data
Jun. 5, 2024 (BR) 1020240113071

(51) Int. Cl. F16L 1/26; F16L 37/00; F16L 37/32

(52) U.S. Cl. CPC F16L 1/26; F16L 37/008; F16L 37/32

(57) ABSTRACT

The present disclosure discloses a device and methods for access to the annular space of submarine flexible pipes through relief valves, which comprises a locking means for fixing the device to a housing of the relief valve after actuation, a means for watertight sealing of an insulation chamber of the device against an internal surface of the relief valve after actuation, and a compensation means. The compensation means is set to cause the locking means to actuate before the sealing means.

### FIELD OF THE DISCLOSURE

This disclosure is part of the technical field of inspection and intervention technologies for offshore petroleum well pipes and risers. More specifically, the present disclosure relates to a portable device for access to the annular space of submarine flexible pipes through relief valves, enabling pressure measurement, removal of fluid sample for analysis or purging of the gas present.

### BACKGROUND OF THE DISCLOSURE

Flexible pipes are tubular structures composed of several overlapping metal (mechanical strength) and polymer (sealing) layers. The annular space is the volume between the inner polymer layer and the outer sheath.

Gas and liquid can permeate into the annular space from both the transported fluid and the external environment (seawater) through leaks. The permeate fluid can cause serious problems for the pipes, such as severe corrosion caused by the phenomenon of CO₂ stress corrosion cracking (SCC-CO₂) or explosion of the outer sheath, in case of excessive accumulation of gas.

The SCC-CO₂ phenomenon can cause premature failure of the metal components of the pipes. This phenomenon occurs when there is the water and CO₂ in the annular space. CO₂ comes from the permeation of this contaminant, when present in the transported fluid. Since it is not possible to avoid the permeation of CO₂ into the annular space, it is important to assess the presence of water in this region. Knowing the condition of the annular space allows the useful life of the pipe to be reassessed, since the presence of water should always be considered when there is no data to state otherwise.

Gas permeation into the annular space, even without contaminants, can cause another type of problem: possibility of outer sheath explosion due to overpressure. To prevent this, relief valves are present at the pipe connectors, as illustrated in FIG. 1. These valves are set to open in case of pressure rise, but malfunctions occur frequently.

Additionally, in pipe deinstallation operations, as the pipe is collected and approaches the surface, the gas present in the annular space expands, being expelled through the relief valves. A major problem in retrieval operations is that, even if the valves act properly, the gas flow rate is still incompatible with the speed of the pipe retrieval speed, and it takes some pauses during operation for the gas to be purged from the annulus. Even so, it is common for outer sheath explosions to occur due to valve failures, which prevents the section from being reused.

One of the ways to access the annulus volume is through devices capable of coupling tightly to the relief valves and, with the use of a pumping system, performing purging, collecting fluid samples, or simply measuring the pressure to infer the condition of the annular space.

Then, considering that access to the annulus can allow significant gains (measurement of internal pressure, collection of fluid sample to assess the presence of water, and higher speeds in pipe collection operations), the biggest challenge is how to obtain the watertight connection between a device (for pressure measurement, sample collection, or pressure relief) and the relief valves installed in the connectors.

Some devices that provide sealing and coupling in relief valves for measuring annular space pressure are known. However, the devices, without exception, use an “arm” that surrounds the entire connector for support and a central cylindrical body equipped with a sealing ring that, when pressed against the relief valves, provide the necessary seal for a pressure measurement or sample collection system to function.

The devices already developed or under development have in common high mass and dimensions, making handling (by ROVs—Remoted Operated Vehicle) more complex. In addition, it is necessary that a dedicated device be developed for each pipe manufacturer, since the relief valves are installed in different locations, and the diameters of the connectors also vary. More particularly, the location of the relief valve also varies by pipe manufacturer, and can be in radial or axial position, as illustrated in FIG. 2, installed on flat or convex surfaces, making existing sealing systems complex and inefficient.

In addition, the presence of accessories installed in the connectors (anodes, dead weight collars, or anchoring, wire ropes, tapes, identification plates etc.) may prevent the use of existing devices, and operations are necessary to remove such interferences beforehand. In some cases, removing the interferences is neither possible nor recommended. Even when possible, it requires time for planning and execution, with the use of boats, which greatly increases the total cost of the inspection.

Therefore, a device is needed for access to the annular space of submarine flexible pipes through relief valves, which allows overcoming various positioning variations, interferences, accessories and conditions of the relief valve surfaces, without the need to encase the connector, for example, using clamps for supporting and coupling the device.

### STATE OF THE ART

In the state of the art there are some devices/tools for inspecting the annular space of pipes, and some of which are applicable to operations carried out by ROV in a submarine environment.

Document BR 1020180750291 discloses a system that allows for the detection of leak tightness or flooding in the annular spaces of flexible pipes using a connector comprising: a piston and cylinder assembly interconnected by a rod to a chamber, which acts as a pilot valve, directly connected to the outlet of a PSV valve on a flexible pipe connector, which are fitted using a sealing and closure system. The operation of the system is managed by commands sent to the ROV, which is equipped with an arm and controls the system via a handler. The disclosure also describes the method of operation of the device and how the results obtained lead to a pre-programmed conclusion of whether the annulus is tightened or not. Other methods envisaged involved obtaining fluid samples in the annulus for further analysis and allowing the removal of PSV from the connectors.

Document BR 1020190258128 discloses a system and method of pressure reduction and annulus drainage of submerged flexible pipes. The document discloses a cylinder and plunger assembly, which is installed in the recess where the relief valve of the flexible pipe connector is present. The cylinder has a sealing system that provides leak tightness between the outer environment and the front region of the cylinder plunger, where the outer part of the relief valve is located. For positioning the cylinder and plunger assembly, and for operating its sealing system, the document discloses a coupling and anchoring system, similar to clamps, controlled through the ROV hydraulic system and handled via the ROV handler, which holds the tool by the handle.

Document BR 1120120176820 refers to pipeline connections for pneumatic and hydraulic control valves. Said document discloses a valve assembly, having a valve body, at least one hole to receive the pipeline, and a collar assembly to attach the pipeline to the hole, wherein the collar assembly is selected from a first collar configured to secure the pipeline by flattening a washer; thus, by driving the washer teeth into the pipeline, and a second collar assembly having a smooth inner surface on which the pipeline is joined, in which both the first and second collar assembly can be threaded interchangeably into the hole.

Document U.S. Pat. No. 3,429,596 refers to a coupling structure. More particularly, to a quick-connect, positive-locking coupling for ducts and tubes formed of any conventional material. Said document discloses a thin metallic locking ring, having a central segmented conical surface against the cam surface of the compression spacer, so that when a hollow cap element mounted on the body and enclosing said ring and said spacer is moved axially, both the seal and the segmented portion of the locking ring are compressed inward to engage the outer peripheral wall of a tube inserted inside and passing through the ring, ring, the spacer, and at least partially into the coupling body.

In view of the of the state of the art disclosure, the characteristics and advantages of this disclosure will clearly emerge from the detailed description below and with reference to the attached drawings.

### BRIEF DESCRIPTION OF THE DISCLOSURE

The present disclosure discloses a device (100) for access to the annular space of submarine flexible pipes through relief valves (12), which comprises a locking means for fixing the device (100) to a housing (13) of the relief valve (12) after actuation, a means for watertight sealing of an insulation chamber (2) of the device (100) against an internal surface (E) of the relief valve (12) after actuation, and a compensation means (10). The compensation means (10) is set to cause the locking means to actuate before the sealing means.

### BRIEF DESCRIPTION OF THE FIGURES

To enhance this description and provide a clearer insight into the features of the present disclosure, a set of figures is presented in which its embodiments are represented in an exemplified, non-limiting manner according to the present disclosure.

FIG. 1 illustrates an exemplary cross-section of a flexible pipe and its connector, disclosing one of the possible positions of the relief valves and other general components according to the present disclosure.

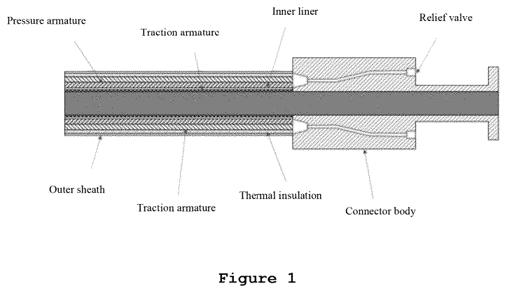

FIG. 2 illustrates an exemplary cross-section of flexible pipe connectors, illustrating radial and axial positions of relief valves according to the present disclosure.

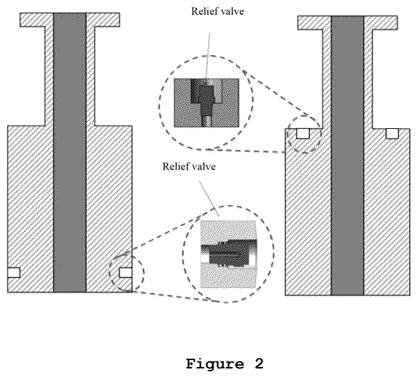

FIG. 3 illustrates a device-focused view of the present disclosure according to the present disclosure.

FIG. 4 illustrates the device with a handle attached and being handled by an ROV handler according to the present disclosure.

FIG. 5 illustrates a sectional view of the device revealing its main elements according to the present disclosure.

FIG. 6 illustrates an ROV alignment maneuver to fit the device into the relief valve housing according to the present disclosure.

FIG. 7 illustrates an exemplary sequence of device operation with sectional views of the device according to the present disclosure.

FIG. 8 illustrates a prototype of the device, illustrating in greater detail an embodiment of the present disclosure that uses two disc springs for locking.

FIG. 9 illustrates a prototype of the device during a test according to an embodiment of the present disclosure.

### DETAILED DESCRIPTION OF THE DISCLOSURE

The present disclosure refers to a device (100) for access to the annular space of submarine flexible pipes through relief valves. The device (100) is capable of coupling tightly to the relief valves and, with the use of pumping means, enable the collection of fluid samples, in addition to measuring and/or relieving the pressure in the annular space.

Access to the annular space volume through the device can provide significant benefits, including: measuring internal pressure (for flooding assessment), collecting fluid samples (to evaluate the presence of water), and achieving higher speeds in pipe retrieval operations.

By reading the annulus pressure at the upper and lower connectors, it can be inferred whether the annular space is flooded, partially flooded or dry. In case of the presence of liquid in the annular space, the disclosure can be used to collect a fluid sample, when used with an accumulator, for later analysis and evaluation of the presence of water and other contaminants.

In addition, the use of the device for prior relief of the annulus pressure can reduce the time spent on pipe retrieval operations. As relief valves have a low flow rate or may not even work, there is a risk of causing the outer sheath of the pipe to explode. In addition to the non-usability of the damaged section, there is also a risk to the operating personnel. Therefore, in addition to the direct gain generated by the shorter vessel time in retrieval operations, there is the potential for fleet optimization and the reuse of pipes.

The proposed device is extremely compact, with dimensions and mass of around 5% when compared to existing models, and has a point contact only in the relief valve housing, which simplifies inspection operations. The dimension and mass reduction achieved is quite expressive, being a device easily handled and transported by a technician. In comparison, state of the art devices can only be manipulated with mechanical assistance.

Moreover, due to its reduced dimensions and the lack of need for the device to encompass the connector/handlers for support, the use of the disclosure becomes more versatile, eliminating the need to remove installed accessories from the connectors (sacrificial anodes, dead weight collars or anchoring, cables, wire ropes etc.) which may cause interference or prevent the coupling of devices using handlers. Moreover, with the reduced dimensions and mass of the device, it is possible to use more than one device simultaneously to access multiple relief valves that are available, to increase the flow rate, when necessary.

The coupling and attachment method to the connector is innovative, as it allows the same device to be compatible with connectors from various manufacturers, regardless of the installation location of the relief valves, requiring only adjustments according to the dimensions of the housings.

The sealing means of the device may be located inside or outside the relief valve housing, depending on the space available around the valve.

For example, in the case of connectors on the seabed, usually in a semi-buried condition, it would be enough for one of the relief valves to be exposed for the device to be coupled, and pre-dredging around the connector would not be necessary, which translates to savings in man-hours (MH) and support vessel time.

Notably, the device has locking and sealing means that does not require the use of clamps to wrap around the connectors. In addition, the device preferentially has two hydraulic interfaces, one with a hydraulic function of sequential locking and sealing control, and the other as a fluid communication route with the annular space of the pipe.

It should be noted that the present disclosure is applicable to any flexible pipe, of any model and manufacturer, that requires inspection of annular space flooding (SCC-CO₂ phenomenon) during its useful life, or at the time of retrieval (deinstallation).

In the first case, the evaluation of the presence of water aims to increase the service life of a pipe susceptible to the SCC-CO₂ phenomenon. Once there is an indication of the presence of water, a sample of this fluid can be taken for analysis through the use of the device of this disclosure. If no water is detected in the annular space, the service life of the pipe can be extended and costs related to removal operations, purchase of new pipe, field installation, and loss of production over time can be avoided.

In the second case, the increase in the speed of pipe retrieval operations has a great impact on the time of vessels used to carry out these operations, generating both financial savings and favoring resource management. Additionally, by preventing the pipe from suffering damage to the outer sheath through depressurization, its reuse becomes possible. It is estimated that 20% of the time is lost in pipe retrieval operations due to pauses for depressurization. In addition to being an expensive resource, the number of vessels dedicated to the installation/uninstallation of pipelines is scarce.

In both cases, pipe inspection or retrieval operations will be more efficient and significantly less costly, eliminating the need for prior removal of installed accessories that could hinder the device connection to the connector.

It will also be appreciated that the compact size of the device in the present disclosure advantageously allows its alignment with the relief valve to be achieved using only the ROV own cameras, eliminating the need for additional cameras or complex centralization systems.

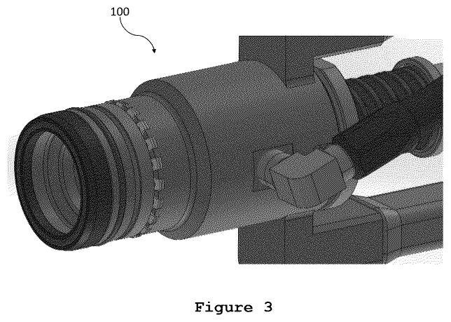

As illustrated in FIG. 3, generally speaking, the disclosure comprises a single multifunction device. This device has an innovative locking means which uses one or more disc springs that, when compressed, expand radially against the walls of the relief valve housing to lock the device.

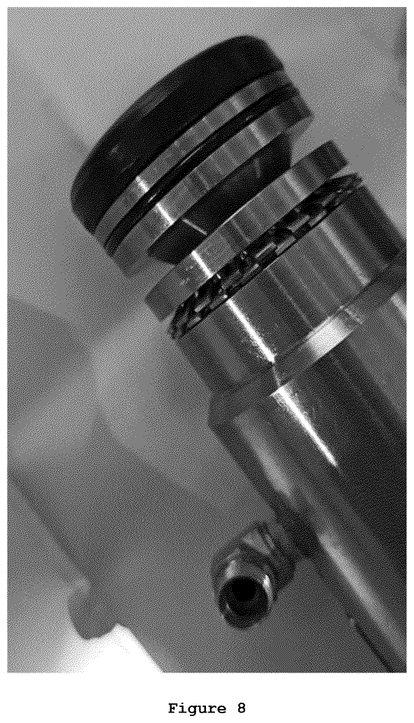

FIG. 8 illustrates a prototype of the device, representing in greater detail an embodiment that uses two disc springs for locking.

Subsequently, after the device is locked, the sealing means advances into the relief valve housing until it presses a sealing ring against the (internal) bottom surface, creating a sealed chamber between the device and the annular space of the pipe. Optionally, the sealing ring can be mounted to seal externally to the housing if there is insufficient space between the valve and the housing walls, with only the locking system remaining inside the housing.

It will be appreciated that both locking and sealing movements are performed through the same hydraulic connection connected to the ROV pressure system, in a logic of sequential movements. That is, through the same hydraulic connection, the device performs both its fixation and insulation of a control volume.

Moreover, it will be appreciated that the locking means is designed to increase the device fixation capacity (100) in the relief valve housing as pressure rises (through hydraulic connection ‘C’). In other words, the higher the applied pressure, the more the locking means secures itself around the relief valve housing.

After locking and sealing, a pressurization/depressurization mechanism can perform pressure measurements, fluid sampling, or depressurization of the annular space, according to the requirements of an operation. Fluids derived from the annular space can be directed to an external system. Fluids derived from the annular space may be conducted to an external system.

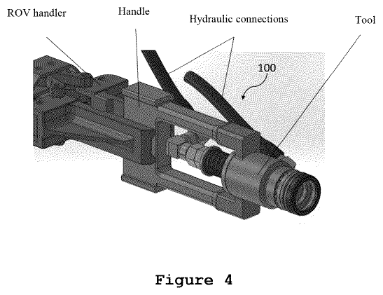

As illustrated in FIG. 4, to facilitate handling of the device by an ROV handler, a handle is provided and attached to the device. Said handle is preferably a substantially flat and flexible material handle, allowing for the support and alignment maneuver of the device for fitting into the relief valve housing. The flexible material of the handle provides compliance in the relative positioning between the ROV and the relief valve, and can also absorb minor shocks if necessary. The flexible material of the handle provides relative positioning compliance between the ROV and the relief valve, and is able to absorb minor shocks if necessary.

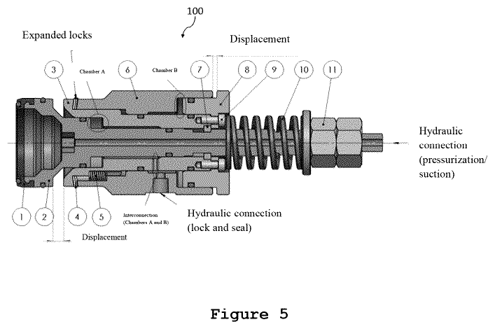

As illustrated in FIG. 5, the device (100) for access to the annular space of submarine flexible pipes through relief valves (12) is preferably composed of at least:
a contact seal (1), which may be manufactured of rigid or compliant (polymeric) material and comprise axial sealing rings at its end;
an insulation chamber (2), which functions to surround the relief valve (or housing), isolating it from the external environment and serving as a pathway for fluid drainage from the annulus, and may also include radial sealing rings;
a bearing (3), which acts as a guide component for the movement of a piston (6) with respect to the insulation chamber (2);
at least one locking spring (4), which functions to secure the tool in the relief valve housing by expanding when compressed;
at least one auxiliary spring (5), which functions to actuate the return of the piston (6);
a piston (6), with movement/displacement that acts to expand or relax at least one locking spring (4)
a split ring (7), which functions to limit the travel of the insulation chamber (2) in relation to the bearing (3);
a mounting flange (8), which functions to limit the movement/displacement of the piston;
mounting screws (9), for fixing the mounting flange (8) to the bearing (3), preferably Allen screws;
compensation means (10), also referred to as a synchronization spring, where adjusting its preload (compression) determines the order of opening and movement of the piston (6) and the insulation chamber (2);
an adjustment element (11), also referred to as adjustment nut, which functions to regulate the compression of the compensation means (10); and
respective hydraulic lines/connections ‘C’ and ‘D’.

It will also be appreciated that the elements of the device (100) include, as needed, seals that allow for relative sliding between different elements of the device. Such seals can be sealing rings, O-rings, gaskets, among others.

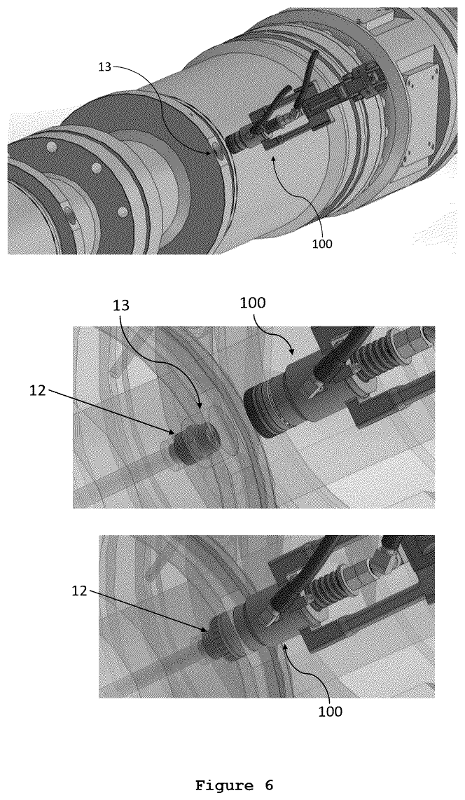

As illustrated in FIG. 6, the device (100), with the handle attached, can be used with the ROV handler, which allows for its support and alignment maneuver for fitting into the relief valve housing. It will be appreciated that due to the reduced volume and mass of the device (100), it can be transported in the ROV drawer, or directly by the ROV handler; in the latter case, when the ROV does not have a transport compartment.

Additionally, as also illustrated in FIG. 6, preferably only two hydraulic connections/hoses are attached to the device: one for the sequential hydraulic control of locking and sealing, and the other for fluid communication with the annular space of the pipe (when the valve is opened).

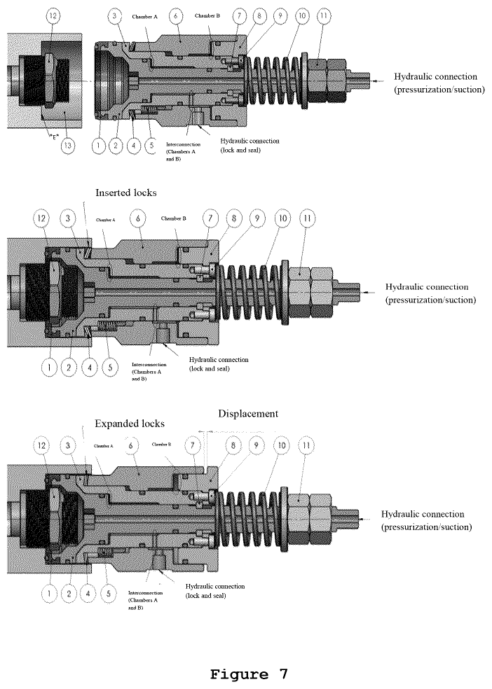

The device (100) operation, as illustrated in FIGS. 6 and 7, will be disclosed in greater detail below.

Initially, upon reaching the inspection site, an operator will approach the device (100) with the contact sealing end (1) facing the relief valve (12) housing (13) and align it as collinearly as possible with the axis of the housing hole, adjusting the positioning visually using the ROV camera.

Once the optimal alignment is confirmed, the device (100) is introduced, observing the compliance of the handle. At this moment, small angular adjustments of the arm are made to reduce lateral friction during insertion. If resistance is encountered during movement, it should be checked whether the locking springs (4) are completely covered by the housing hole, which indicates complete penetration.

Then, the device (100) should be kept supported by the ROV until the activation of the hydraulic function of a proportional valve of the ROV pressurizes the chambers ‘A’ and ‘B’, respectively, through the first hydraulic route/connection (C). The hydraulic pressure exerted by the first hydraulic route/connection (C) results, at first, in the movement of the piston (6), which will act to compress the locking springs (4), causing them to expand against the walls of the housing hole (13), keeping them in a wedged position.

Then, after the piston (6) completes its stroke/movement, and through the same hydraulic actuation of the hydraulic route/connection (C), the displacement of the insulation chamber (2) (and contact seal (1)) is then initiated until the contact with the inner surface (E) of the coupling (13) of the relief valve (12), since chambers ‘A’ and ‘B’ are communicating vessels. With the piston movement (6), a displacement between the piston (6) and a mounting flange (8) will be observed.

It will be appreciated that the forward movement of the insulation chamber (2) begins when the expansion movement of the locking spring (4) ceases. This sequence (synchronization) of movements results from the adjustment (or pre-load) of the compensation means (10). Said adjustment (tightening or loosening) is carried out by the adjustment element (11) with the intention of compensating for a difference between the areas in chambers ‘A’ and ‘B’, in such a way that the device (100) is not ejected from the housing (13) before its locking means is activated.

The compensation means (10) can be a helical spring, flat spring, disc spring, or another energizing means that allows for adjustment.

Once the above activation is complete, the ROV should detach from the device (100) handle and preferably transfer the handler to a monkey first (an accessory used in ROV tethers to handle locking clamps, for example), which can be pre-installed on the tool in a location that does not interfere with the operation.

At this point, a system attached to the actuator device (100) for pressurization/depressurization must apply pressure through the second hydraulic route/connection ‘D’, to check whether the locking spring (4) was successful, and when finished, the ROV will be able to release the monkey first and move away to follow the remainder of the operation.

Upon completing depressurization or fluid collection operations involving the annular space, monitored by an onboard pressure sensor connected to an acquisition electronic system, a reverse procedure should be carried out.

In this context, the reverse procedure may involve the ROV approaching, docking on the section, supporting the device (100) with the handle, and relieving the hydraulic pressure from the tool locking means, resulting in the separation of the insulation chamber (2) from the face/surface ‘E’ and the return of the locking spring (4) to its resting state, with the latter action being assisted by the set of three auxiliary springs (5).

To assist in complete detachment, the ROV may apply an axial force to push the device (100) against the housing, followed by a slight rotation between 0 and 45 degrees, clockwise or counterclockwise, to shift the contact points of the locking spring (4) edges, followed by pulling and retrieving the device (100) to begin another inspection operation, if required.

It is worth noting that the internal pressurization action of the insulation chamber (2) will enhance the action of the locking spring (4), as this pressure increase will affect chambers ‘A’ and ‘B’ equally, as they are communicating vessels, further ensuring that the device (100) does not slip out of the relief valve (12) housing (13).

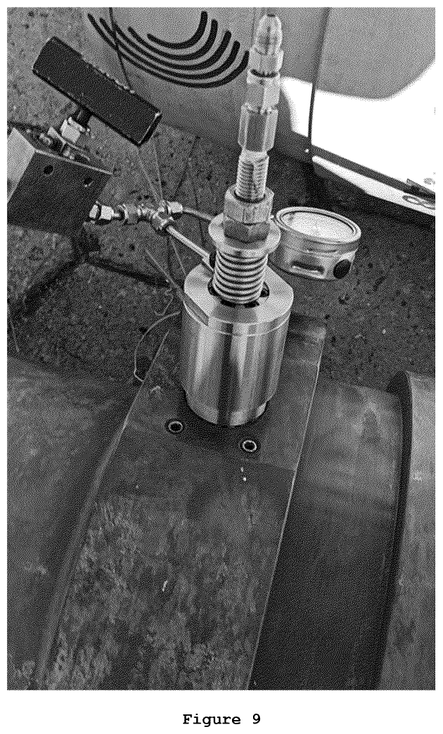

FIG. 9 illustrates a prototype of the device during a test to evaluate its locking and sealing capabilities in the relief valve. The prototype of the device performed as designed, maintaining its coupling and leak tightness even with high pressures applied to the device.

Based on the above, it will be appreciated that the device (100) of the present disclosure has at least the following advantages.

### Economic and Productivity Advantages

Pipes subject to the presence of CO₂ in the produced fluid should be inspected regularly for the presence of water. Otherwise, the possibility of the SCC-CO₂ phenomenon should be considered, with reduction of the service life and indication of replacement of the pipe with production stoppage. Therefore, the use of the device (100) for inspections to evaluate the presence of water and contaminants in the annular space allows the recalculation and possible extension of the pipe service life.

In addition, the use of the device (100) for prior depressurization of the annular space in pipes to be retrieved/uninstalled offers several benefits. Pipe retrieval operations are carried out in stages, with pauses in between to allow gases to be expelled through relief valves as they expand near the surface. In recent years, the need for pauses during the retrieval has generated an estimated loss of about 70 days per year. The prior depressurization of pipes using the device (100) of this disclosure would allow the retrieval in continuous operations, which would ensure less time for vessels dedicated to these operations and, consequently, the optimization of this scarce and expensive resource.

### Health and Safety Advantages

use of the device (100) for prior The depressurization of the annular space of the flexible pipes to be retrieved reduces the chances of explosion of the outer sheath on the deck of pipe laying support vessels (PLSVs). Even if the retrieval is paused for purging, it is not uncommon for the relief valves to malfunction and, consequently, the gases present in the annular space not to be eliminated. Expansion during operation and the explosion of the outer sheath may occur after retrieval, on the deck, posing a risk to operators.

### Environmental Advantages

The device (100) allows access to the annular space environment for prevention inspection of the SCC-CO₂ phenomenon, which can cause catastrophic failure of the pipe and, consequently, failure to containment of the produced fluid. More serious cases can result in leakage in production pipes.

### Reliability Advantages

The knowledge of the fluid present in the annular space of flexible pipes, through the current device (100), allows calculation of the service life of the pipe with greater precision, reducing the risk of failures and avoiding the replacement of the pipe before the end of its service life.

### Preferred Embodiment

A preferential embodiment of this disclosure is a device (100) to access the annular space of submarine flexible pipes through relief valves (12), comprising:
a locking means for fixing the device (100) in a housing (13) of the relief valve (12) after actuation;
a watertight sealing means of an insulation chamber (2) of the device (100) against an inner surface (E) of the relief valve (12) after actuation; and
a compensation means (10),
wherein the sealing means and locking means are both actuated sequentially by a first hydraulic connection (C),
wherein the compensation means (10) is configured to compensate for a difference in hydraulic actuation pressure of the sealing means with respect to the locking means, such that the locking means is actuated before the sealing means, and
wherein the insulation chamber (2) of the device (100) comprises a fluid connection with a second hydraulic connection (D).

The locking means comprises at least one locking spring (4), which when compressed by a piston (6) actuated through the first hydraulic connection (C), expands radially against the housing (13) of the relief valve (12) to lock the device. The locking spring (4) is preferably a disc spring.

The sealing means comprises at least one insulation chamber (2) and contact seal (1), which when moved into contact with an inner surface (E) of the coupling (13) of the relief valve (12), create a space for watertight sealing of the insulation chamber (2).

The compensation means (10) is a synchronization spring, which comprises at least one adjustment element (11) to regulate the preload (compression) of the spring and thus determine the sequential order of actuation of the locking means and the sealing means, respectively.

Thus, the skilled in the art will value the knowledge presented herein and will be able to carry out the disclosure in the presented embodiment and their variants covered in the scope of the claims below.

1. A device to access the annular space of submarine flexible pipes through relief valves, the device comprising:
locking means for fixing the device in a housing of the relief valve after actuation;
watertight sealing means of an insulation chamber of the device against an inner surface of the relief valve after actuation; and
compensation means,
wherein the sealing means and locking means are both actuated sequentially by a first hydraulic connection,
wherein the compensation means (10) is configured to compensate for a difference in hydraulic actuation pressure of the sealing means with respect to the locking means, such that the locking means is actuated before the sealing means, and
wherein the insulation chamber of the device comprises a fluid connection with a second hydraulic connection.

2. The device according to claim 1, wherein the locking means comprises at least one locking spring, which when compressed by a piston actuated through the first hydraulic connection, expands radially against the housing of the relief valve to lock the device.

3. The device according to claim 2, wherein the locking spring comprises a disc spring.

4. The device according to claim 1, wherein the sealing means comprises at least one insulation chamber and contact seal, which when moved into contact with an inner surface of the coupling of the relief valve, create a space for watertight sealing of the insulation chamber.

5. The device according to claim 1, wherein the compensation means comprises a synchronization spring comprising at least one adjustment element to regulate the preload of the spring, so that the locking means is actuated before the sealing means.

6. The device according to claim 1, further comprising a compliant handle attached, for use with an ROV handler.
